(19) United States
(12) Patent Application Publication
(10) Pub. No.: US 2003/0200447 A1
(43) Pub. Date: Oct. 23, 2003

(54) Identification system

(75) Inventor: Hans Sjoblom, Are (SE)

Correspondence Address: NIXON & VANDERHYE, PC, 1100 N GLEBE ROAD, 8TH FLOOR, ARLINGTON, VA, 22201-4714, US

(73) Assignee: Lotta Almroth, Vasteras (SE)

(21) Appl. No.: 10/324,136

(22) Filed: Dec. 20, 2002

Related U.S. Application Data
(60) Provisional application No. 60/341,259, filed on Dec. 20, 2001.

(30) Foreign Application Priority Data
Aug. 17, 2001 (SE) 002935-5

(51) Int. Cl. H04L 9/00

(52) U.S. Cl. 713/186; 713/176

(57) ABSTRACT

A user verification system responding to voice commands comprises a control unit (11, 21), input means (221) for receiving voice commands and output means (224, 225) for presenting information to the user. The control unit (21) is adapted to create a hash value from one or more received voice commands which is presented to the user by use of the output means (224, 225). The input means (221) is adapted to receive the hash value from the user in form of a spoken message, and the control unit is further adapted to verify the identity of the user based on the received hash value.

### TECHNICAL FIELD

The present invention relates generally to a user identification and verification system, and more particularly to a speech-based system which receives voice commands from a user in order to perform specific actions as well as to verify the identity of the user and to verify that the user is present in person.

### PRIOR ART

When a person wants to make use of a service provided by an electronic system, such as a banking network, the user must satisfy certain security requirements, i.e. the system that provides services requires some form of identification to authenticate the person before providing the requested services. The authentication may take various forms, but the main purpose is to verify that the person requesting services or goods is in fact who that person claims to be.

The de facto standard and most straightforward method to authenticate a person in an electronic system before providing services is to use secret passwords. This is a simple and in most cases reasonably safe way to make sure that no unauthorized person makes use of the system, but at the same time a person who is authorized to access the system will have to go through one or more authorization procedures and enter his or her password at least once during the procedure. For example, many Internet based stock brokers request a first password from the user for permitting access to the actual Internet site, and a second password in order to allow trade with stocks.

To keep the security at a sufficiently high level the password has to be made up of many characters in a random fashion, and it also has to be changed frequently to make sure that no unauthorized person gets hold of the password.

This implies that the user has to remember all the passwords he uses, which may be cumbersome if the person is using many different services. He may also write down the passwords as an alternative to remembering them, but this will of course reduce the security level significantly.

As the user finally becomes authenticated he then has to enter one or more commands for being able to perform the desired actions, such as transferring money to and from an account or buying/selling stocks. Both the authentication procedure and the procedure of entering commands require the user to handle a keyboard as well as making selections from different menus shown on a computer display. Although the user goes through an authentication step when he seeks access to the system, the user also in many cases has to- authenticate his or her claimed identity before performing an important action, such as transferring money.

Many persons with less or no computer experience find this authentication procedure very difficult and frustrating to perform since entering commands by use of a keyboard is not the normal way for a human being to communicate.

Another approach to authenticate a person using a system is to obtain biometric characteristics from the person in question. Today, many different forms of biometric data can be obtained from dedicated biometric sensors in order to verify the identity of a person. The biometric data may be provided through the use of finger prints, retinal scan, etc. The most natural way, however, for a person to provide biometric data to a system is to use the own voice. Systems are available today, which are capable of analyzing and interpreting spoken words as well as verifying the identity of the person speaking.

U.S. Pat. No. 6,081,782 discloses a communication system which is able to verify the identity of a person using the system by analyzing the voice characteristics of the person in question. The disclosed system is also capable of interpreting the spoken words and perform certain actions based on the voice commands. When a user of the system wants to make a telephone call to his or her home, the user simply says “Call Home”. The system then matches a model of the voice command against a stored model for the user and performs the requested action if the voice command corresponds to the model. The system also compares the voice characteristics contained in the actual command with the vocal characteristics of the stored model in order to verify the identity of the user.

U.S. Pat. No. 6,016,476 discloses a system with a portable client in form of a personal digital assistant (PDA) which comprises an audio processor for processing speech information. In similarity to the system described above, this system is also capable of performing certain voice commands which the user speaks into a microphone. The audio processor is also used to verify the identity of the user by analyzing the voice of the person using the PDA. In addition to analyzing the voice of the user, the system comprises one or more biometric sensors, e.g. a fingerprint reader.

However, none of the systems disclosed in the prior art documents address the problem of using the voice to verify that the user is present in person. In both prior art documents it is possible for a fraudulent person to monitor a specific session, such as a money transfer operation or a purchase of goods, and record the voice commands uttered by the authorized user. At a later stage, the unauthorized user may then play back a collection of individually correct commands in order to perform a desired action.

### SUMMARY OF THE INVENTION

It is an object of the present invention to provide a system that is protected against the above-mentioned kind of fraudulent use. Furthermore, it is an object of the present invention to provide a system which allows the user to be authenticated in a simple and reliable way without the need for the user to enter cumbersome passwords and commands.

Another object of the present invention is to provide a system which makes it easy for a user with less computer experience to perform advanced actions, such as buying a house, transferring money, etc. without the need of a keyboard.

The above objects are achieved by providing a user verification system that responds to voice commands uttered by the user and which system comprises input means for receiving the voice commands, a control unit for processing the received commands, and output means for presenting information to the user. More specifically, the control unit is adapted to create a hash value from one or more received voice commands which are subsequently presented to the user by use of the output means. The input means is adapted to receive the hash value from the user in form of a spoken message and the control unit is adapted to finally verify the identity and the presence of the user based on the received hash value.

Other objects, features and advantages of the present invention will appear from the following detailed disclosure, from the appended claims as well as from the accompanying drawings.

### BRIEF DESCRIPTION OF THE DRAWINGS

A preferred embodiment of the present invention will now be described in more detail, reference being made to the accompanying drawings, in which:

FIG. 1 is a schematic drawing of the different components of the arrangement according to the present invention, FIG. 2 is an alternative embodiment of the arrangement of FIG. 1,

FIG. 3 is a flow chart of the method for verification of a user according to a preferred embodiment of the present invention, and

FIG. 4 is yet another alternative embodiment of the present invention making use of a Smart Card

### DETAILED DISCLOSURE OF A PREFERRED EMBODIMENT

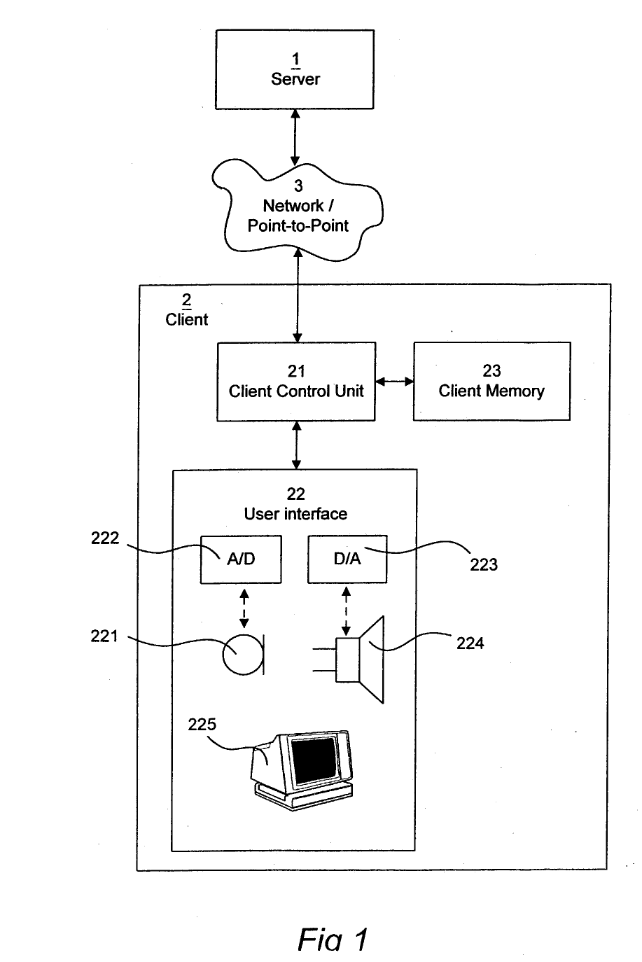

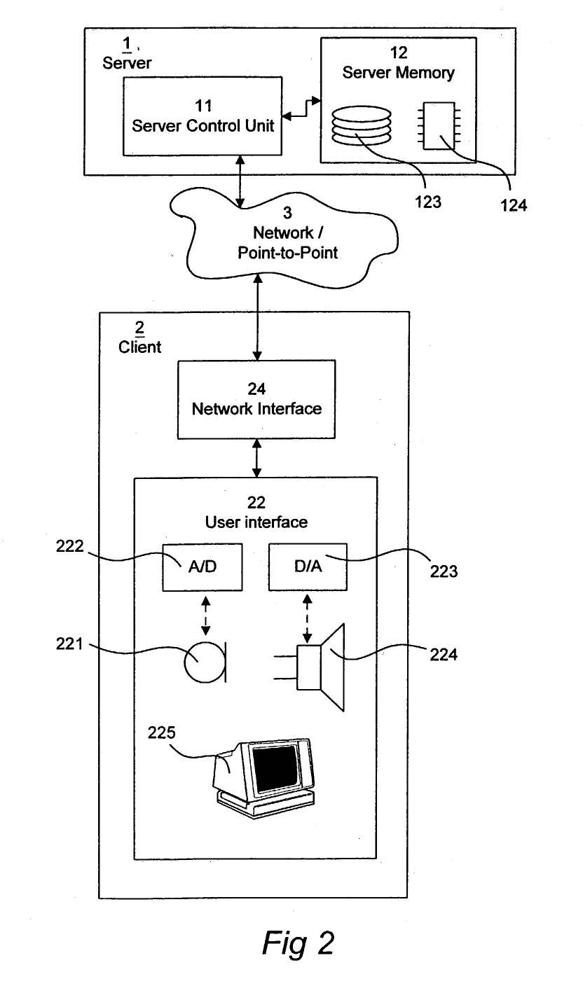

A preferred embodiment of the present invention will now be described with reference to FIG. 1. An enterprise, such as a bank, a broker, a travel agency, a real estate agent, or any other business which provides services or products of some kind to a user at a client station 2 has a server application software located at a server station 1. The server application software responds to commands from a user at a client station 2 through a network connection 3. The client 2 may be in form of a stationary computer (PC), a mobile telephone, a personal digital assistant (PDA), or any other electronic device that is able to communicate with other electronic devices. It is appreciated that the network 3 may be part of a global network, such as the Internet, or may be a point to point connection, such as a telephone connection, which in turn may be realized in many different ways, e.g. by means of cable or by radio waves.

The user at the client station 2 interacts with a client application software running on a client control unit 21 by means of voice commands. A user interface 22 receives spoken commands or other spoken information through an input means, such as a microphone 221. The user interface comprises an analog-to-digital converter 222 for transforming the electrical signal from the microphone into digital numbers, which may be processed by the client control unit 21. The client application software is capable of interpreting the received spoken commands and perform actions based on these commands. This technique is well known in the art and is thoroughly disclosed in the patent documents referred to in the prior art section and will hence not be disclosed further in this application.

Further, the client application software also performs a first verification of the user identity in order to determine that the user is who he or she claims to be. This may be done by comparing the voice characteristics of a spoken command with a model of the user voice characteristics stored in a client memory 23. In order to protect the client memory 23 from any fraudulent unauthorized person trying to alter the contents of it, the memory 23 is preferably of an EPROM-type comprising a security fuse bit or any other suitable safe guarding technique to protect its contents. However, other kinds of storage media are equally possible within the scope of the invention. The technique of using voice characteristics preferably relies on voice features rather than a particular language, which means that different language and dialect users can operate the system without special training.

To present information to the user, the client control unit 21 transfers the information to the user interface 22, which besides an analog-to-digital converter 222 also comprises a digital-to-analog converter 223 for transforming the digital numbers into an analog signal. The digital numbers are preferably a synthesized speech representation of the information that is to be presented to the user at the client station 2. After transformation, the analog information signal is presented to the user as spoken words by means of a loudspeaker 224. Alternatively, the information from the client control unit 21 may be presented to the user as written words on a display 225.

In a preferred embodiment of the invention all voice processing/synthesizing steps are performed by the client application software at the client station 2, which implies that the communication between the server station 1 and the client station 2 through the network 3 will not call for a broad band connection and may be performed by means of inexpensive and well-established techniques, such as Internet based packet switching.

FIG. 2 illustrates an alternative embodiment of the invention in which the client control unit 21 and the dedicated client memory 23 has been replaced by a server control unit 11, which is preferably realized as a software routine running on the server station 1, and a server memory 12, which may be a hard drive 123, a solid state memory 124 (RAM, EPROM, EEPROM, etc) or any other suitable storage medium.

In this embodiment, the control function is transferred from the client station 2 to the server station 1, and the client control unit 21 has been replaced by a simpler network interface 24. The network interface receives information from the user interface 22 in the same way as the client control unit 21 (FIG. 1) received information in the preferred embodiment. One difference, however, is that the network interface 24 does not perform any processing of the received information. Instead it simply adapts the format of the received voice commands to comply with the communication protocol of the network 3. This embodiment will naturally call for a higher band width of the connection between the server 1 and the client 2 since more information will be transferred back and forth over the network 3.

Once received at the server station 1, the spoken commands are processed by the server control unit 11 in order to determine which action the server control unit 11 is to perform and in order to make a first verification of the user identity. The voice command interpretation and voice verification steps taken at the server station 1 are analogous to the steps taken by the client control unit 21 (FIG. 1) in the preferred embodiment.

As mentioned above, the service provider at the server station 1 may be any enterprise that sells services or goods. For clarity reasons, however, the disclosure of a method for verifying the identity of a authorized user according to the invention will be directed towards a service provider in form of a bank.

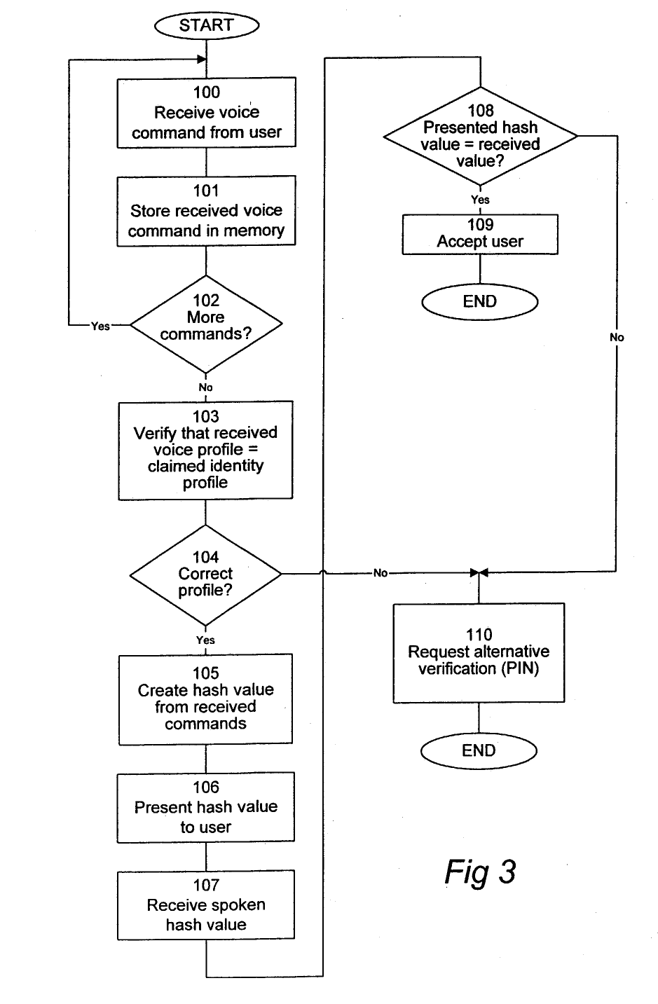

FIG. 3 illustrates a flow chart of the method for verifying that a user of the client station 2 is actually present in person and is not represented by a recorded message. For clarity reasons, the steps known from the prior art showing the interpretation of the commands has been omitted in FIG. 3.

The routine starts in step 100 when the client control unit 21 in FIG. 1 receives a voice command from the user. In a subsequent step 101 the client control unit 21 stores the command in the client memory 23. Thereafter, in step 102, the client control unit 21 awaits more commands from the user. If the command input session is not complete, the routine jumps back to step 100 where the client control unit 21 receives more commands.

For example, let us assume that the user of the client station 2 wishes to make an immediate money transfer of $100 from his or her own account to another persons account. A typical command input session then starts with the voice command: “Transfer”. Through the user interface 22, the client control unit 21 then presents the user with a question asking from which account he wishes to make the transfer. The user replies with a second command: “My personal account”. The command input session carries on with the client control unit 22 asking questions to the user which in reply gives instructions to the system: “100 dollars”, “To account number 123456”, “Transfer today”, etc.

When the command input session is complete, the routine continues to step 103 and the client control unit 21 performs a first verification of the user identity according to the discussion above. This first verification may however as well be performed between every received command from the user (i.e. in step 101).

If the verification procedure turns out negative in step 104, the user is presented with the option to verify his or her claimed identity by entering a personal identification number (PIN) in step 110, either as a spoken command or by means of a keyboard if such an input means is available.

If the verification procedure turns out positive, the client control unit in step 105 creates a hash value based on the received commands. To avoid collision, i.e. when two different inputs produce the same hash value, the client control unit 21 adds a time stamp to the stored sequence of commands before creating the hash value. Alternatively the client control unit 21 creates a random number which is subsequently added to the stored sequence of commands. By doing so the security of the system is increased since a fraudulent user will not be able to calculate the hash value even if he knows which commands are used throughout the session. In the alternative embodiment, where the control functionality has been transferred to the server control unit 11, the server control unit 11 performs the task of adding the time stamp or the random number to the stored sequence of voice commands.

The hash function is always a one way function and many different more or less complex hash functions are available for use with the system according to the invention. For example, the “Division-Remainder” method may be used which starts with the estimation of the number of stored commands (including the time stamp) in the memory. The estimated number is then used as a divisor for each stored command (in digital form) in order to extract a quotient and a remainder. The remainder is then used as hash value for the stored sequence of commands. One drawback of this simple method, however, is that it is liable to produce a number of collisions.

Another simple hashing method is “Folding” where the original commands first are divided into several parts, whereupon the different parts are added together. An arbitrary number of digits of the least significant part of the sum are then used as hash value.

Yet another hashing function to be used is “Radix Transformation”. This method is based on changing the number base (or radix) of the digital value of a command. This will result in a different sequence of digits. For example, a command with a decimal base representation could be transformed into a corresponding hexadecimal base representation. After transformation of the command number, the high-order digits could be discarded to create a hash value of uniform length.

However, the actual selection of hash function is of lower importance. The simple functions described above are just few examples of functions that may be used. There are several well-known hash functions used in the area of cryptography and database storage. Examples of these one way hash algorithms are the so-called message-digest hash functions MD2, MD4, and MD5 from RSA Security Inc, 20 Crosby Drive, Bedford, Mass. 01730, USA, which are used for hashing digital signatures into a shorter value called a message-digest. In addition to this there is the Secure Hash Algorithm (SHA) which was invented by the National Security Agency (NSA) as part of the US government Digital Signature Standard (DSS).

When the hash value has been created by use of any suitable hash function, the value is presented to the user at the client station 2 in step 106. The hash value may be presented as is, i.e. a sequence of letters or digits. For example, if the hash value is “112268134”, the control unit 21 divides the complete hash value into sub values of a shorter length, e.g. “112”, “268”, and “134” and presents these values to the user at the client station 2. The user is then prompted to utter the sub values as spoken words, i.e. “one hundred twelve”, “two hundred sixty eight”, and “one hundred thirty four”.

Alternatively, the hash value may be transformed into a sequence of words based on the result from the calculation of the hash value. For example, if the resulting hash value is “4−16−8”(1+1+2, 2+6+8, and 1+3+4), the user is prompted to utter the fourth, sixteenth, and eighth word spoken during the command input session. In a preferred embodiment of the invention, the control unit 21 must receive the reply from the user at the client station 2 within a specified time limit, e.g. 3 seconds, in order to accept the reply as valid. This means that if a fraudulent user at the client station 2 is using a prerecorded sequence of commands, he will not be able to select and play back the different requested commands from the recording within the specified time limit. As an alternative the user may be requested to utter the fourth, sixteenth, and eighth word from a random database of words available in the memory 23 of the client 2 or the server 1.

In step 107 the system receives the spoken hash value from the user and, in step 108, compares the received value with the presented value.

If the outcome of the comparison is negative, the user is presented with the option to verify his or her claimed identity by entering a personal identification number (PIN) in step 110, as was the case with the negative outcome from the first verification in step 104.

If the user utters the correct sequence of digits or words corresponding to the hash value, the system will accept the user and perform the requested action. In accordance with the example above this may be to transfer $100 from the users own account to account number 123456. At a later stage, the user may use the added time stamp for verification purposes, i.e. the user is able to track all sessions back in time by examining the time stamps. This may be helpful if the user suspects a misuse of his or her identity. If a specific session is marked with a time stamp that the user clearly knows is not correct (i.e. he or she has not performed the desired actions at the recorded point of time), he or she may block the use of the claimed identity.

It is also understood that, in an alternative embodiment of the invention, the server station 1 and the network 3 may be omitted. The client station 2 will then act as an independent unit. This embodiment may be useful if the invention, for example, is to be used to access secure information located locally in a database on a hard drive on a stationary computer.

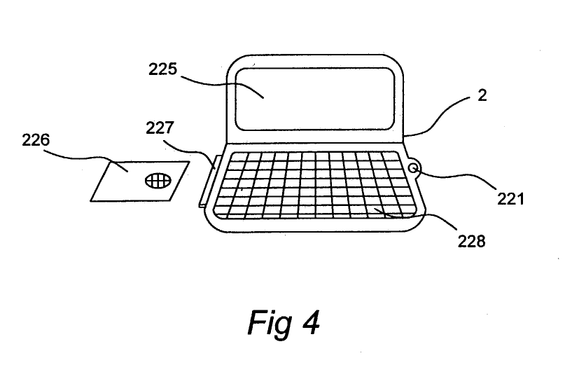

Additionally, as seen in FIG. 4, the client application software may reside on a Smart Card 226, which is bought from the service/product provider. For example, the user at the client station 2 may purchase a “Buy a car” application software from a car dealer. After plugging the Smart Card 226 into a reader 227 connected to the local client computer 2, the user is guided through all the necessary steps to buy a car and responds to the questions asked without the need to use a keyboard 228, which however may be used if available. The information related to the purchase including the approval of the purchase from the authorized user is then stored on the Smart Card.

The user may thereafter either send the Smart Card 226 to the car dealer by mail or log on to a network, such as the Internet by means of cable, radio, light or any other suitable communication medium, or use a direct phone line to the car dealer in order to complete the purchase. The identity and the intentions of the buyer are verified by the use of the application software, and are securely stored on the Smart Card 226.

The degree of security required for the transfer of the Smart Card 226 information depends on the estimated risks of interference by a fraudulent third party, i.e. a purchase of a valuable car may need a higher degree of security than an ordering of a newspaper subscription.

Generally, the responsibility for providing the required security level during information transfer primarily lies on the network operator or the delivery firm in question. However, if the purchase information is transferred over a network connection or a phone line, the client computer 2 may request an on-line receipt from the receiving party indicating a complete and correct transfer of information.

Additionally, to increase the security level even further, each message that is transferred between the server station 1 and the client station 2 may include a certificate (i.e. the message may be encrypted by use of PKI infrastructure) ensuring the origin of the message content. A fraudulent person trying to interfere with the information transaction will then not be able to alter the message content without detection.

The invention has been described above with reference to a preferred embodiment. However, the present invention shall in no way be limited by the description above; the scope of the invention is best defined by the appended independent claims. Other embodiments than the particular one described above are equally possible within the scope of the invention.

1. A method for verifying the identity of an individual at a client station (2), comprising the steps of obtaining (100) voice data from the individual at the client station, comparing (104) the data received from the individual with data from one or more records of enrolled individuals, characterized by the steps of:
creating a hash value (105) from one or more received voice commands,
presenting (106) the hash value to the user,
receiving (107) the hash value from the user in form of a spoken message, and
verifying (108) the identity of the user based on the received hash value.

2. The method according to claim 1, where the spoken hash value must be received (107) from the user within a specified time limit after the presentation of the hash value to the user.

3. The method according to claim 1 or 2, where the verification step is performed at the client station (2).

4. The method according to claim 1 or 2, where the verification step is performed at a server station (1).

5. The method according to claim 4, where the verification data is transferred from the client station (2) to the server station (1) by means of a network (3).

6. The method according to claim 4, where the verification data is transferred from the client station (2) to the server station (1) by means of a point to point connection.

7. The method according to any preceding claim, where the hash value is presented to the user in form of sound from a loudspeaker (224).

8. The method according to claim 1-6, where the hash value is presented to the user by means of a display (225).

9. A user verification system responding to voice commands comprising a control unit (11, 21), input means (221) for receiving voice commands and output means (224, 225) for presenting information to the user, characterized in that
the control unit (21) is adapted to create a hash value from one or more received voice commands,
the output means (224, 225) is adapted to present the hash value to the user,
the input means (221) is adapted to receive the hash value from the user in form of a spoken message, and
the control unit is further adapted to verify the identity of the user based on the received hash value.

10. The system according to claim 9, where the control unit (11, 21) is adapted to prevent an individual from using the system if the spoken hash value is not received from the user within a specified time limit after the presentation of the hash value to the user.

11. The system according to claim 9 or 10, where the control unit (21) is located at the client station (2).

12. The system according to claim 9 or 10, where the control unit (11) is located at the server station (1).

13. The system according to claim 12, where a network interface (24) is adapted to transfer verification data from the client station (2) to the server station (1) through a network (3).

14. The system according to claim 12, where a network interface (24) is adapted to transfer verification data from the client station (2) to the server station (1) through a point to point connection (3).

15. The system according to claim 9-14, where the output means is a loudspeaker (224).

16. The system according to claim 9-14, where the output means is a display (225).

17. A computer program product directly loadable into the internal memory (12, 23) of an electronic apparatus with digital computer capabilities (1, 2), characterized in that the computer program product comprises software code portions for performing the steps of any of the claims 1 to 8 when said product is run on said apparatus (1, 2).
